(19) United States
(12) Patent Application Publication
(10) Pub. No.: US 2006/0115037 A1
(43) Pub. Date: Jun. 1, 2006

(54) System and a method of automatically sorting objects

(76) Inventors: Niels Hald Pedersen, Hvidovre (DK); Jesper Cramer, Vanlose (DK); Anders Evald, Birkerond (DK)

Correspondence Address: HUSHEXCLUSIVE, 1295 BEACON STREET, P.O. BOX 531, BROOKLINE, MA, 02446, US

(21) Appl. No.: 10/530,769

(22) PCT Filed: Oct. 10, 2003
(86) PCT No.: PCT/DK03/00685

§ 371 Date: Sep. 26, 2005

(30) Foreign Application Priority Data
Oct. 11, 2002 (DK) PA 2002 01548

(51) Int. Cl. G21G 1/06; B07C 5/16

(52) U.S. Cl. 376/159; 209/592

(57) ABSTRACT

This system relates to a system ( and a corresponding method ) of automatically sorting objects, wherein said system comprises a conveyor mechanism configured for conveying an object to a sorter device; a sensor device arranged such that the objects conveyed are caused to be located essentially within a predetermined reading space; and a calculator unit configured for receiving an electrical sensor signal representative of measurement data from said sensor device and configured for generating and emitting a control signal to said sorter device configured for sorting conveyed objects in response to/on the basis of said control signal, wherein said sensor signal is configured for detecting gamma radiation emitted from a conveyed object when exposed to a neutron flux with a given energy distribution, and configured for providing said sensor signal on the basis of said detection; and wherein said control signal is generated on the basis of said sensor signal. Hereby expedient and reliable automated sorting of objects is provided, wherein the frequency of erroneous sorting is dramatically reduced, the system using another and more reliable analysis method than was previously used. Moreover, the number of sorting errors is reduced to a level that is sufficient for complying with the requirements made with respect to the environment.

This invention relates to a system and a method of automatically sorting objects, including objects contained in a flow of waste.

More specifically the invention relates to a system (and a corresponding method) comprising a conveyor mechanism configured for conveying an object to a sorter device; a sensor device arranged such that the object conveyed is caused to be located essentially within a predetermined reading space; and a calculator unit configured for receiving an electrical sensor signal representative of measurement data from said sensor device and configured for generating and emitting a control signal to said sorter device configured for sorting conveyed objects in response to/on the basis of said control signal.

Often it is advantageous to be able to sort objects on the basis of an associated class from a number of possible classes. Sometimes the amount of possible classes is limited to comprise only a few classes, such as ‘metallic’ and ‘non-metallic’, eg when flows of environmentally problematic waste are to be sorted. In that case it is necessary to be able to determine common features for each sorted object belonging to a specific class, said features relating the object to the given class despite possible variations within each class.

Sorting of flows of material is extremely important in a large number of production processes, and in the establishment of a socially viable economy of materials, the sorting of waste flows will play an increasingly important part. Sorting may serve the purpose of eg minimising or eliminating the presence of harmful substances in recyclable flows of waste. Sorting may also be used in connection with on-line monitoring of outgoing flows from plants that treat household waste or particular types of waste, wherein the waste product, eg the sludge from combustion plants, needs to observe threshold values in respect of several elemental substances in order to be suitable for recycling or be deposited in the most inexpensive manner.

Sorting may also serve the object of ensuring a minimum concentration of a desired component in connection with recycling.

Separation of materials in case of manual sorting is often erroneous in case of those flows of material, where the visual features of objects are very similar, and furthermore this kind of sorting requires considerable resources, eg in case of manual tasks. When waste sorting is concerned, where correct categorisation is of the utmost importance primarily for environmental considerations, such manual sorting with a risk of a high frequency of sorting errors is undesirable.

Sorting of eg pressure-impregnated timber from non-impregnated timber is not a simple matter, as it may be an extremely difficult task to distinguish these two from each other, in particular as the timber ages and/or if the surface of the timber is coated.

Typically, two types of waste timber are dealt with that it is important to distinguish between:
pressure-impregnated timber: typically this timber is temporarily deposited as, to a wide extent, it contains large amounts of heavy metals, such as copper, chrome, arsenic and boron. At present there is no environmentally acceptable and economically viable method of treating it.
non-pressure-impregnated timber: it can be disposed of by incineration.

According to a survey (Iben V. Kristensen: Identifikation og sortering af affaldstræ vha. Farvereaktion (Identification and sorting of waste timber by colour reaction), Workshop i Affaldsstrategier for imprægneret træ (Workshop on waste strategies for impregnated timber) Borås 2001-11-14) about 60% of unimpregnated waste timber was erroneously categorised as impregnated timber in manual sorting processes. Correspondingly about 16% of impregnated waste timber was erroneously categorised as unimpregnated timber.

This high percentage of errors is environmentally unacceptable, in particular in the light of the circumstance that the amount of impregnated waste timber is expected to multiply in the next few years to come. As mentioned pressure-impregnated timber typically contains heavy metals such as cupper, chrome, arsenic and boron that are unacceptable pollutants.

Methods of chemically analysing an amount of heavy metal present in a given object are known. However, it is inconvenient to apply such method eg in the sorting of waste objects, since the amount of waste timber is increased and such analysis is both time-consuming and economically cumbersome.

It is therefore advantageous to provide a system by which objects can be sorted in a simple, reliable, expedient and rational manner.

U.S. Pat. disclosure No. 4,830,193 concerns sorting lumps of gold-bearing minerals by means of neutron activation analysis, wherein gamma radiation and neutron irradiation occur at different times. More specifically the mineral lumps are sorted into two groups depending on size and are irradiated, following which the intensity of gamma rays, having an energy of 297 KeV, is subsequently measured and either accepted or rejected in response to the measured intensity at 297 KeV.

Patent No. GB 2 055 465 also relates to determination of the gold content of a material by use of neutron activation analysis, wherein the material is irradiated with neutrons and wherein the intensity of gamma rays having an energy of 279 KeV (probably 297 KeV was intended) was subsequently determined to achieve acceptance or rejection.

Patent No. EP 0 059 033 relates to sorting of ore, wherein ore is bombarded with neutrons by a number of irradiation units to form isotopes. The gamma radiation is detected—emitted by isotopes of elements such as gold—by a number of detectors, thereby enabling identification of the isotopes. It says that it is normally required that all ore particles are subjected to at least substantially the same amount of irradiation and a solution is provided.

It is therefore the object of the invention to provide a system that is able to efficiently, reliably and inexpensively classify objects with a view to sorting them on the basis of specific criteria by means of a contact-free and expedient sensor system.

This object is accomplished by a system of the kind mentioned above, and wherein said sensor device is based on Prompt Gamma-Neutron Activation Analysis (PGNAA) and comprises a neutron source configured for emitting neutrons; a moderator surrounding said neutron source and said measurement space, and configured for moderating said emitted neutrons; and a detector configured for detecting gamma radiation emitted by an object arranged within said measurement space when the object is exposed to a neutron flux with a given energy distribution; and generation of said electrical sensor signal on the basis of said detection; and wherein said control signal is generated on the basis of said sensor signal.

Hereby expedient and reliable automated sorting of objects is provided, whereby the frequency of erroneous sorting is dramatically reduced, the system using another and more reliable analysis method than was previously used. A system according to the invention presents the advantage that, in addition to being automated, the number of sorting errors is reduced to a level that is sufficient for complying with the requirements made with respect to the environment.

Typically a system according to the invention may multiply the number of processed objects compared to previous methods.

The sorting system may be configured eg for sorting timer into heavy-metal-containing timber or non-metal-containing timber, respectively. Alternatively the sorting system may be configured for sorting plastics into PVC-containing plastics or PVC-free plastics.

According to an alternative embodiment said sensor device further comprises a gamma shield and/or a neutron shield, wherein said gamma shield is located between said source and said measurement space, and/or wherein said neutron shield is located between said detector and said measurement space.

Hereby a minimisation of the flux of thermal neutrons into the detector is obtained due to the neutron shield/screen which causes a dampening of the measured noise level.

According to a preferred embodiment, said sensor device further comprises a gamma shield arranged around said neutron source, thereby minimising direct radiation of gamma from the neutron source to said neutron source.

According to one embodiment said sorting system is configured for sorting a flow of waste.

According to a preferred embodiment said detection is accomplished contact-free in relation to the object. Hereby a reduction in operating costs is achieved due ia to the minimal wear that occurs in connection with a touch-free embodiment and economies in respect of manual labour.

According to one embodiment an estimate is provided of the amount of sample material in said measurement space on the basis of gamma radiation of an elemental substance, eg hydrogen, aluminium, silicon or iron, present in the sample material in a known concentration.

The described sensor technology is designated Prompt Gamma Neutron Activation Analysis (PGNAA) and is a well-known technique.

By PGNAA the object is irradiated with neutrons with relatively low kinetic energy (so-called thermal neutrons) from a suitable source, whereby the cores of the elemental substances become unstable and immediately fall back to a state of reduced energy while emitting gamma radiation with a characteristic energy.

More specifically, a reaction between an atomic nucleus and a thermal neutron is designated neutron capture and results in the nucleus changing atomic weight corresponding to the mass of the neutron. This process will leave the nucleus in an excited/energy-rich state, from which it decays momentarily while emitting gamma radiation characteristic of the nucleus in question. This gamma radiation is designated ‘prompt gamma’ as it is emitted momentarily.

Both neutrons and the resulting gamma radiation are very penetrating and it follows that even massive objects can often be analysed in a contact-free manner.

A Prompt Gamma Neutron Activation Analysis (PGNAA) method is based on the fact that all elemental substances can react with low-energetic neutrons, the so-called ‘thermal neutrons’.

The various elemental substances have very different capacities when it comes to reacting with thermal neutrons. This capacity is designated by a value typically designated the reactive cross section which varies by more than 11 value factors throughout the periodic table of the elemental substances without apparent systematics.

Apart from the reactive cross section, the sensitivity to PGNAA of a given elemental substance varies, on the one hand, with the amount and kind of the emitted gamma radiation and, on the other, with the nature of the detector system.

This analysis technique is well-suited for detecting treated objects that are not readily visually distinguishable, such as pressure-impregnated timber, as it is possible, on the one hand, to measure through voluminous objects such as posts and poles relatively unaffected by surface layers such as paint and, on the other, wherein elemental substances such as cupper, chrome, arsenic and boron have such high reactive cross-sections that a determination of the concentrations seems to be possible.

As far it is known, practical use of PGNAA has been restricted to characterisation of coal in power plants, ore within the mining industry and raw-material mixtures for cement furnaces and the like. The invention shows how PGNAA can also be used for sorting waste.

Typically an embodiment is used, wherein said sensor device primarily uses hydrogen as moderator due to the high moderator effect of hydrogen.

According to an alternative embodiment said sensor device primarily comprises carbon material as moderator (rather than hydrogen). The scattering cross section of carbon and hence its performance as moderator is smaller than the performance of hydrogen; however, carbon has a far smaller absorption cross section, which yet again entails improved utilisation of neutrons and considerably less noise in the form of undesired gamma radiation. Also the use of a hydrogen-poor moderator enables an almost direct measurement of the hydrogen content of the object, on the basis of which an estimate of the amount of timber in the reading space can be calculated; this part measurement being necessary for determining the concentration within an object.

According to one embodiment the system is configured for receiving measurements of objects of a known classification; and wherein the classification unit comprises means for calculating weight factors of a number of weighted sums established by a multivariable data analysis, calibration on an, iterative method by which an incremental refining successively provides an improved set of weight factors.

According to an alternative embodiment, said control signal is provided by the classification unit on the basis of signals comprising said weight factors and said sensor signal.

According to one embodiment said sensor signal comprises a gamma spectre representing recorded gamma radiation intensity within a given photon/energy range.

According to one embodiment said control signal (307) is provided on the basis of the difference between a sensor signal (306) and a predetermined reference spectre obtained with empty measurement space (6) and stored in a memory unit (403).

The invention also relates to a method of automatically sorting objects, wherein the method comprises
conveying at least one object to a sorter device;
wherein said conveyance causes conveyed objects to be essentially within a predetermined reading space of a sensor device; and
receiving an electrical sensor signal representing measurement data in a calculator unit/classification unit from said sensor device and generating and emitting a control signal to said sorter device configured for sorting objects on the basis of said control signal;
   wherein the method further comprises
emitting neutrons from a neutron source in said sensor device;
moderating said emitted neutrons by means of a moderator in said sensor device, wherein said moderator surrounds said neutron source and said measurement space;
detecting, on the basis of Prompt Gamma-Neutron-Activation Analysis (PGNAA) by a detector in said sensor device, gamma radiation emitted from an object within said measurement space when it is exposed to a neutron flux with a given energy distribution, and providing said sensor signal in said sensor device on the basis of said detection; and
generating said control signal on the basis of said sensor signal.

According to one embodiment the method comprises minimisation of the flux of thermal neutrons into the detector by means of a gamma shield and/or a neutron shield in said sensor device; wherein said gamma shield is arranged between said source and said measurement space and/or wherein said neutron shield is arranged between said detector and said measurement space.

According to one embodiment the method comprises further minimisation of direct gamma radiation from the neutron source to said detector by means of a gamma shield arranged around said neutron source in said sensor device, such that radiation of gamma rays from source to detector is attenuated.

According to one embodiment the method comprises sorting of a flow of waste.

According to one embodiment said detection is performed contact-free with respect to the object.

According to one embodiment an estimate is provided of the amount of sample material in said measurement space on the basis of gamma radiation of an elemental substance, eg hydrogen, aluminium, silicon or iron, present in the sample material in a known concentration.

According to one embodiment said sensor device primarily comprises carbon material as moderator.

According to one embodiment the method comprises receipt of measurements of objects of a known classification and calculation of weight factors of a number of weighted sums established by a multivariable data analysis, calibration or an iterative method by which incremental refining successively brings about an improved set of weight factors.

According to one embodiment the method further comprises that said control signal is provided by the classification unit on the basis of signals comprising said weight factors and said sensor signal.

According to one embodiment cluster analysis is used as a step in automatically generating suggestions for categorising sample objects on the basis of patterns in measurement data corresponding to said objects.

According to an embodiment said sensor signal comprises a gamma spectre representing registered gamma radiation intensity within a given photon/energy range.

According to one embodiment said control signal (307) is provided on the basis of the difference between a sensor signal (306) and a predetermined reference spectre received with empty measurement space (6) and stored in a memory unit (403).

The method according to the invention and embodiments thereof correspond to the system according to the invention and embodiments thereof and present the same advantages for the same reasons.

The invention will now be explained in further detail in the following with reference to the drawing; wherein

FIG. 1 schematically illustrates a cross section of an embodiment of a sensor device according to the invention;

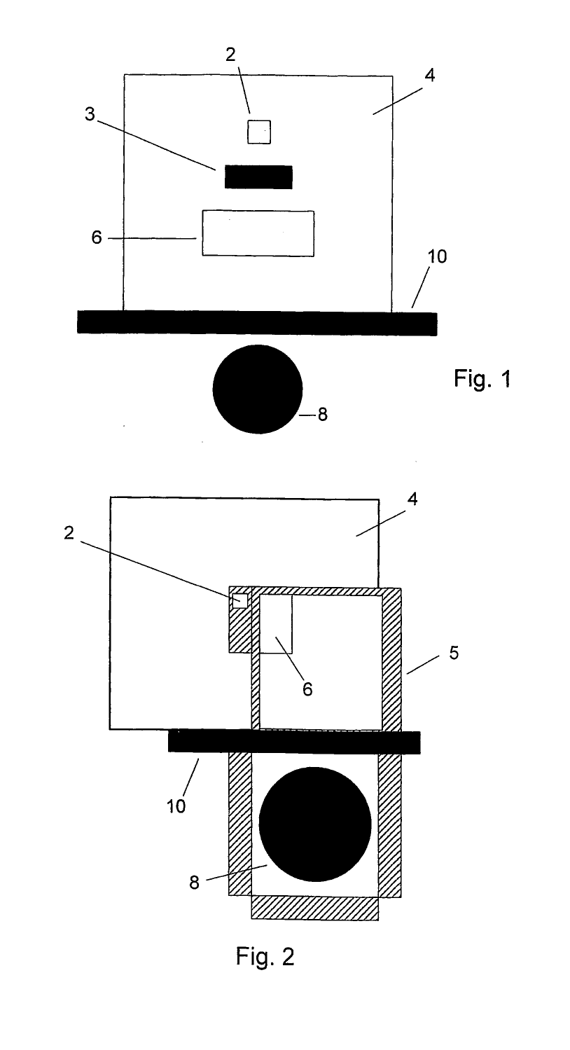

FIG. 2 schematically illustrates a cross-section of an alternative embodiment of a sensor device according to the invention;

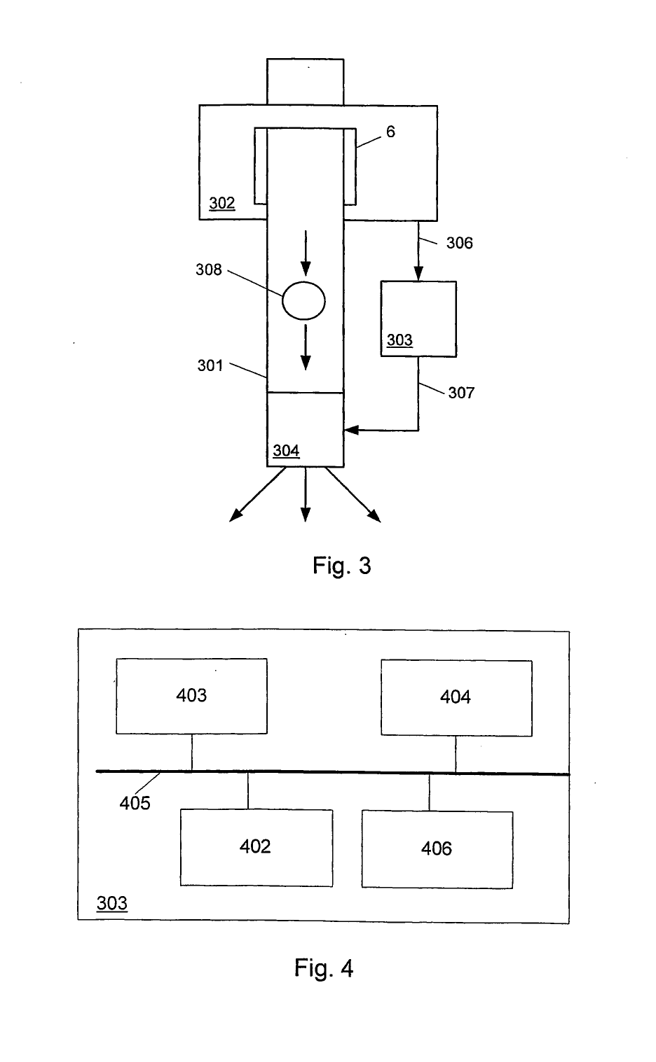

FIG. 3 illustrates an embodiment with conveyor mechanism, sensor and sorter device and a classification unit.

FIG. 4 shows an embodiment of a classification unit according to the invention;

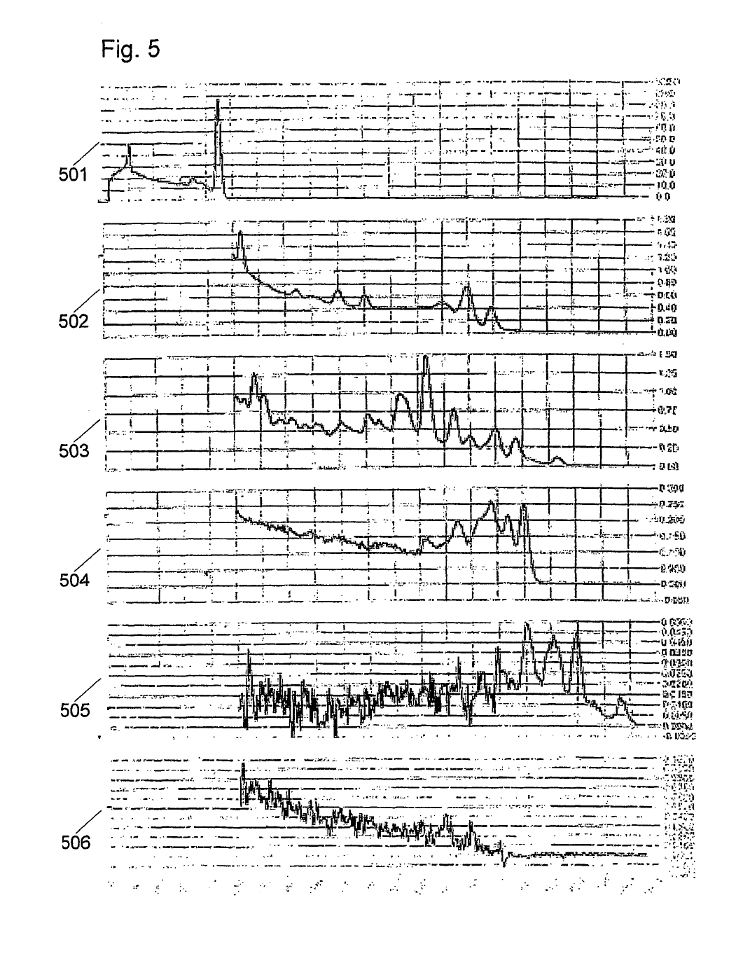

FIG. 5 shows examples of PGNAA spectres.

FIG. 1 schematically illustrates a cross section of a part of an embodiment of a sensor device (302) according to the invention and comprising a neutron source (2), a moderator (4), a measurement space (6), a gamma shield (3), a neutron shield/a neutron screen (10) and a detector/sensor (8).

The neutron source (2) emits a neutron flux, ie neutrons with high kinetic energy, and is surrounded by a moderator (4) that serves the purpose of moderating the neutrons to thermal velocities. The moderator (4) comprises a massive volume of a material having a large content of a number of elemental substances (eg hydrogen and carbon) with high scattering cross-sections such as paraffin, polyethylene, graphite or water. In the moderator (4) there is thereby formed an area containing thermal neutrons that will, following a number of scatterings, no longer have a predominant direction. In this embodiment, the measurement space/the three-dimensional measurement area (6) has a well-defined volume/space within which a uniform and high neutron flux is established through a convenient shaping of the moderator (4) which typically, to a large or small extent, surrounds said measurement space (6). The measurement space (6) may have many different configurations, eg depending on the relevant objects to be sorted.

The detector (8) that captures gamma radiation emitted by objects arranged within the measurement space (6) will typically be sensitive to both thermal neutrons and gamma radiation emitted by the neutron source (2) and the moderator (4) and radiation from natural nucleides in the surroundings of the sensor device. Preferably both gamma (3) and neutron shielding (10) materials will be arranged in convenient places within the reading area. The detector (8) may eg be of the scintillation type, eg tallium-doted sodium-iodide; but it may also be of other types, eg the semi-conductor type. The latter detectors, however, typically presuppose a cooling, eg by means of liquid nitrogen, which makes practical use thereof rather difficult.

In practice all neutron sources, such as isotope or accelerator-based sources, emit almost exclusively neutrons with high kinetic energy (within a range 10⁶-10⁷ eV). To attain thermal neutrons (kinetic energy of a range of 0,025 eV) the source is surrounded by the moderator (4) that consists of a material of a high scattering cross-section and a low absorption cross section. Preferably the moderator consists of hydrogen-containing materials, such as water, paraffin or polyethylene, etc. In such moderator a neutron will, during its lifetime within the material, scatter elastically several times and, as described previously, it will lose energy at each collision until the energy level corresponds to the thermal movement of the moderator's atoms.

Preferably a moderator material is used that primarily contains carbon instead of hydrogen. The scattering cross section of carbon and hence its performance as moderator is smaller than the performance of hydrogen; however, carbon has a far smaller absorption cross section which, in turn, means that an improved neutron utilisation is accomplished and far smaller noise in the form of undesired gamma radiation. Additionally the use of a hydrogen-poor moderator enables an almost direct measurement of the hydrogen content of the object, on the basis of which an estimate of the amount of material (eg plastics or timber) contained in the reading space can be calculated, as this part measurement is requisite in order to enable determination of the concentration of an object.

Following initial processing of a number of detecting events collected by the detector (8) in a number of gamma ranges within a predetermined time, these data are subjected to a transformation; weighted sums of the set of measurement variables being provided. For a PGNAA sensor each individual variable is constituted of the number of obtained detector events per time unit within a given gamma-quantum-energy range. The weight factors for calculating the weighted sums can be provided by multivariable regression analysis, by calibration or by iterative method, by which an improved set of weight factors is accomplished by incremental refining. Multivariable analysis is based on an approach to multi-data characterised in that underlying variation patterns are identified and used by means of methods known from mathematical statistics. For instance, signals from PGNAA sensors are multivariable, as the individual signal is present as a plurality of variables. For calibration, measurements of sets of objects having known classification can be used. A reference point in a multidimensional space of a number of dimensions corresponding to the number of measurement variables is associated with each individual class or classification. The individual reference point can be calculated as the average of the measurement points representing the objects belonging to the relevant class.

PGNAA can be utilised for a contact-free in-depth elemental substance analysis of eg waste or recycling material. Neutrons as well as the resulting gamma radiation measured by the detector system being very penetrating, even solid objects can often be analysed contact-free by this method. Since contact-free systems do not suffer from the same degree of wear as is the case with non-contact-free systems, it is therefore desirable to use contact-free systems for an application such as eg waste sorting, since very often the objects to be analysed consist of fragments of very varying shapes. Moreover the rate at which a flow of objects can be processed can typically be increased.

The measurement signal for a given object is preferably defined as the simultaneous change of all variables detected when an object is conveyed through the reading space and subsequently measured during a time interval relative to a measurement with an empty measurement space. Overall, the information on the basis of which the classification unit-is to conclude is described as a vector consisting of a sequence of numerical values.

Ideally a given elemental substance in the measurement space will give rise to a measurement signal of a given pattern and proportional with the amount of the relevant elemental substance. The overall measurement signal is then the sum of these contributions.

FIG. 2 schematically illustrates a cross-section of a part of an alternative embodiment of a sensor system according to the invention. The neutron source (2) and a gamma shield (5), eg a lead shield, around same is arranged such that direct radiation of gamma from the neutron source (2) is minimised. The measurement space (6) is located close to the source where the neutron flux is high and a comparatively thick moderator material (4) between the detector (8) and the source (2) and a neutron shield (10) minimise the flux of intermediate neutrons into the detector (8) which causes an attenuation of the measured noise level.

FIG. 3 illustrates an embodiment of the system according to the invention comprising a conveyor mechanism (301), a sensor (302), a sorter device (304) and a classification unit (303). Preferably, in addition to the described sensor device (302), the system comprises a conveyor mechanism (301) for conveying objects (208) to and from the measurement space/reading area (6); a determination/calculation/classification unit (303) for processing measurement data from the sensor device (302) and determining to which fraction/group a given object (308) belongs; and a sorter device (304) for sorting objects (308) on the background of the decisions of the calculation/classification unit (303). A sorting object (308) may eg be waste to be sorted, optionally with a view to recycling and/or expedient further processing.

For each object (308), the decision system (303) determines to which group it belongs based on data/information received from the sensor device (302) preferably in the form of measured gamma radiation such as eg number of recorded quanta and their energy distribution.

Alternatively the system may comprise one or more further sensors, wherein the calculation/classification unit (303) is further configured for receiving and processing data originating from such other sources. The further sensors(s) may be eg sensors for temperature measurement, measurement of neutron flux within the measurement space, gamma densiometry of objects, weighting cells, image-forming sensors (eg “vision”—TV camera+frame grabber), image-forming x-ray scan or other types of sensors (not shown).

According to one embodiment the calculator unit (303) is configured for calculating concentrations of relevant elemental substances, which may occur on the basis of an estimate of the sampled amount. Given the sample material contains a well-defined concentration of hydrogen, eg water, plastics or timber, this estimate may be provided by use of a hydrogen-poor moderator that enables an almost direct measurement of the hydrogen contents of an object, on the basis of which an estimate of the amount of object (eg amount of timber) in the reading space could be determined with useful accuracy. The estimated amount of object can then be used to estimate the current concentration of the elemental substances. In general an estimate of the amount of sample material in said measurement space is provided on the basis of gamma radiation of an elemental substance, eg hydrogen, aluminium, silicon or iron, present in the sample material in a known concentration.

The decision system is explained and disclosed in further detail in the context of FIG. 4.

The conveyor mechanism (301) is able to advance objects (308) by means of a conveyor belt, knob belt or the like, pushing or pulling mechanisms, pneumatic conveyance or the like, seizing or guiding mechanisms (including robot systems), etc.

The sorter mechanism/sorter device (304) may for instance be realised as belt or guiding mechanism (eg a funnel device) that changes direction, as ejector with arm or jet of air or other medium, seizing mechanisms (including robot systems), etc.

In one embodiment where the conveyance mechanism (301) is a seizing mechanism (including robot), the conveyor (301) and sorter mechanism (304) may be one and the same.

A system according to the invention can be used eg for sorting pressure-impregnated timber from other timber, sorting PVC from other plastics materials, etc.

FIG. 4 shows an embodiment of a classification unit (303) according to the invention comprising one or more microprocessors (402) and/or one or more digital signal processors (406); a memory unit (403) and means for receiving and emitting signals (404) connected via a common data/address bus (405). The microprocessor(s) (402) and/or the number of digital processors (406) interact with the memory unit (403) and the means for receiving/emitting signals (404). The means for receiving and emitting signals (404) are responsible for communication with the number of available sensors, including the sensor device (302) and user interfaces, if any. The communication between the classification unit (303) and external units such as the sensor device (302), the sorter device (304), etc, may occur eg by means of IrDa, Bluetooth, IEEE 802.11, wireless LAN, etc. but it may also be executed by means of conventional permanent links. The memory unit (403) may store relevant information such as a dedicated computer programme and classification variables, calibration data, processing algorithms, etc. The memory unit (403) preferably comprises volatile and/or non-volatile memory units, such as ROM, RAM, magnetic memory, optical memory and combinations thereof.

Processing of data may also be comprised in one single multi-functional processor. The use of multi-functional processors instead of dedicated digital signal processors may be advantageous in connection with some embodiments. Albeit digital signal processors are extremely suitable for handling signal calculation in a system, most embodiments also require a microprocessor for other tasks such as memory handling, user interaction, etc. Therefore it may be advantageous to use a multi-functional processor which is capable of performing all of the mentioned task types in order to thereby reduce the number of components and to minimise the power consumption and production costs, etc. Reduction of the number of processors to one will also mean that fewer sets of instructions are to be mastered during the development of this classification unit.

Data from a PGNAA analysis are in the form of gamma spectre and preferably the difference between a reference spectre recorded with empty measurement space (stored in memory unit (403)) and a relevant spectre provided via the sensor device is used. This difference is processed by the calculator unit(s) (402; 404) with a view to determining a class for the relevant object.

Preferably the measurement signal/sensor signal from the detector comprises a gamma spectre per measurement (alternatively it is an option to mediate across a number of spectres in order to reduce noise). Such spectre may consist of eg 1024 integers, where the spectre represents the number of recorded events (ie gamma radiation intensity) within a given photon-energy-range (see eg FIG. 5). The observed patterns/profiles are specific to the individual elemental substance. In case a number of elemental substances are present in the measurement space, the pattern/profile for each elemental substance will be added, preferably to the relative amount of the relevant elemental substance and the absolute sensitivity of the apparatus relative thereto.

Since, typically, there will always occur slight variations in the internal amplification of the detector, offsets of the observed spectra will occur. To remedy this, a correction can be performed on the basis of identified known constant and invariant peaks. Moreover measurement can be corrected in the event of decay of the neutron source during the measurements.

According to a preferred embodiment, spectres are split into a smaller number of windows to limit the number of variables and to reduce random noise.

The window splitting involves a reduction of the random noise while conserving as much multivariable signal as possible. As opposed to this, splitting into a few windows reduces the most noise, while many windows conserves the most of the multivariable signal. Since both measurements are critical to a good data analysis, the determination of the optimal number of windows is important. The optimal number and the positions of the windows depend on the relevant task, ie which set of possible elemental substances is to be analysed in the relevant embodiment. A general example of a splitting of spectres with 1024 integers is splitting into ten windows covering the gamma field 2-10 MeV.

Alternatively other methods can be used for recognizing the amount of elemental substances contained in a given object. These other methods can use eg neural networks, other pattern-recognition procedures, etc.

FIG. 5 shows examples of PGNAA spectres. The spectre depicts the distribution of gamma energy against the intensity of a given energy, the horizontal axis of the spectre being divided into 1024 channels, such that each channel corresponds to 10 KeV, and the number of recorded recordings per second in the relevant channel is depicted in the vertical axis of the spectre. A peak around channel 225 thus corresponds to a gamma energy of 2.25 MeV.
Spectre 1 (501) shows a detector signal from an empty measurement space. The prominent peak around 2.25 MeV is caused by prompt gamma from capture of neutrons in the hydrogen in an approximately 30-kilo heavy moderator of polyethylene. The low signals primarily consist of scattered radiation from this peak.
The energy range from 2.5 MeV to 10 MeV is seen to contain only very little signal. This very important signal range is increased in spectre 2 (502).
Spectres 3, 4, 5 and 6 (503, 504, 505, 506) show in same sectional view and energy range differences for empty measurement space and 299 g of PVC, 234.7 g of copper, 27.4 g of chrome or 31.8 g of arsenic, respectively, within the measurement space. Thus these spectres represent typical measurement signals wherein the peaks observed on the spectres are characteristic for the elemental substance in question.

For each of substances Cu, Cr, Ar and Cl measurements were performed on a number of model objects, wherein the only significant signal-emitting elemental substance was one of the mentioned ones. Then, by multivariable regression analysis a predictor (a function for indicating the contents) was calculated for each these elements. The predictor was calculated on the basis of the total measurement sequence, as elemental substances other than the relevant ones are then considered as interferences.

The predictors are robust as they are simultaneously and independently of each other able to predict the amount of the individual elemental substances. In the determination of the elemental substances in question, levels of significance were determined. Levels of significance are calculation factors that partake in the estimation of the performance of a full-scale plant.

The levels of significance can be determined as the ratio between the signal magnitude and the standard deviation on the background. The signal is determined on the basis of the difference between the average of the predictors for reference object and all of the samples. As the standard deviation on the background the observed one is used on all of the samples for the current predictor.

On the basis of a calibration—in the current case to be understood as an establishment of a prescription for how a measurement signal is converted into a classification—the system is able to determine and sort an object within a given category. The calibration is validated to search for the ability to classify new measurement data. If the system is unable to identify the difference necessary for the classification in relation to proximate classes, said calibration may result in a negative acceptance, whereby the system is able to eg report to which objects or classes the problems relate. These objects may then optionally be subjected to renewed measurement, or the classification problem can be reformulated to the effect that the object classes the system is having problems distinguishing are combined.

It applies to all object classes that a more comprehensive calibration, ie more objects, more elemental substances, more measurements, etc, will most likely increase the levels of significance. This will apply in particular to arsenic, where the determination clearly suffers from lack of spectral information and improved suppression of interferences.

Due to the elevated absorption cross-section and characteristic emission spectre of Cl in combination with the contents of chlorine in PVC being typically about twice the magnitude of the content of elemental substances of interest in pressure-impregnated timber, touch-free sorting of plastics in a PVC-containing and PVC-free fraction, respectively, will thus be considered to constitute a technology that could be implemented in a system according to the invention. Thus sorting of other types of waste flows could also benefit from the present invention.

Automatic categorisation is a substantial element during the construction of a self-calibrating and user-friendly analysis plant; such plant having to be able to be calibrated by means of a set of objects that combine to represent the scattering that may occur during measurement. Following a number of completed sample measurements the system comes up with a suggested sort key that is refined interactively in cooperation with an operator.

Examples of automatic calibration include a so-called cluster analysis performed on a five-dimensional set of data consisting of predictions for Cu, Cr, As, Cl and B.

Cluster analysis is a technique for organising a number of points in a piece of timber, whereby the points that are most proximate each other are most proximate in the timber. A cluster analysis presupposes that, to each point, a position is associated in an n-dimensional space, and that this space is associated with a distance code, whereby the term ‘distance’ makes sense. The analysis is performed by identifying the two most proximate points in a data set. They are replaced and form a node to which the halfway position between the two points is allocated. Now the node replaces the two original points in the data set. The process is repeated until only one node remains.

1. A system of automatically sorting objects, wherein said system comprises:
a conveyor mechanism (301) configured for conveying at least one object (308) to a sorter device (304);
a sensor device (302) arranged such that conveyed objects (308) are caused to be located essentially within a predetermined reading space (6); and
a calculator/classification unit (303) configured for receiving an electrical sensor signal (306) representing measurement data from said sensor device (302) and configured for generating and emitting a control signal (307) to said sorter device (304) configured for sorting conveyed objects (308) on the basis of said control signal (307),
characterised in
that said sensor device is based on Prompt Gamma-Neutron Activation Analysis (PGNAA) and comprises
a neutron source (2) configured for emitting neutrons;
a moderator (4) surrounding said neutron source (2) and said measurement space (6), and configured for moderating said emitted neutrons; and
a detector (8) configured for detecting gamma radiation emitted by an object (308) arranged within said measurement space (6) when the object (308) is exposed to a neutron flux with a given energy distribution, and generation of said electrical sensor signal (306) on the basis of said detection; and
that said control signal (307) is generated on the basis of said sensor signal (306).

2. A system according to claim 1, characterised in that said sensor device (302) further comprises a gamma shield (3) and/or a neutron shield (10), wherein said gamma shield (3) is located between said source (2) and said measurement space (6) and/or wherein said neutron shield (10) is arranged between said detector (8) and said measurement space (6).

3. A system according to claim 1 or 2, characterised in that said sensor device (302) further comprises a gamma shield (5) arranged around said neutron source (2) such that direct radiation of gamma from the neutron source (2) to said detector (8) is minimised.

4. A system according to claim 1, characterised in that said sorting system is configured for sorting a flow of waste.

5. A system according to claim 1, characterised in that said detection is performed contact-free with regard to the object (308).

6. A system according to claim 1, characterised in that an estimate of the amount of sample material in said measurement space (6) is provided on the basis of gamma radiation of an elemental substance, eg hydrogen, aluminium, silicon or iron, present in the sample material in a known concentration.

7. A system according to claim 1, characterised in that said sensor device primarily comprises carbon material as moderator.

8. A system according to claim 1, characterised in that the system is configured for receiving measurements of objects with a known classification; and that the classification unit (303) comprises means for calculating weight factors of a number of weighted sums established by multivariable data analysis, calibration or iterative method, by which an improved set of weight factors is successively attained by incremental refining.

9. A system according to claim 8, characterised in that said control signal (307) is provided by the classification unit (303) on the basis of signals comprising said weight factors and said sensor signal (306).

10. A system according to claim 1, characterised in that cluster analysis is used as a step in automatic generation of suggestions for categorising sample objects on the basis of patterns in measurement data corresponding to said objects.

11. A system according to claim 1, characterised in that said sensor signal (306) comprises a gamma spectre representing registered gamma radiation intensity within a given photon/energy range.

12. A system according to claim 1, characterised in that said control signal (307) is provided on the basis of a difference between a sensor signal (306) and a predetermined reference spectre obtained with empty measurement space (6) and stored in a memory unit (403).

13. A method of automatically sorting objects wherein said method comprises
conveying at least one object (308) to a sorter device (304); wherein said conveyance causes conveyed objects to be essentially within a predetermined reading space (6) of a sensor device (302);
receiving an electrical sensor signal (306) representing measurement data in a calculator unit/classification unit (303) from said sensor device (302); and
generating and emitting a control signal to said sorter device (304) configured for sorting conveyed objects (308) on the basis of said control signal (307); characterised in that the method further comprises
emitting neutrons from a neutron source (2) in said sensor device (302);
moderating said emitted neutrons by means of a moderator (4) in said sensor device (302), wherein said moderator (4) surrounds said neutron source (2) and said measurement space (6);
detecting, on the basis of Prompt Gamma-Neutron-Activation Analysis (PGNAA) by a detector (8) in said sensor device (302), gamma radiation emitted from an object (308) within said measurement space (6) when it is exposed to a neutron flux with a given energy distribution, and providing said sensor signal (306) in said sensor device (302) on the basis of said detection signal (306); and
generating said control signal (307) on the basis of said sensor signal (306).

14. A method according to claim 13, characterised in that the method comprises minimisation of the flow of thermal neutrons into the detector by a gamma shield (3) and/or a neutron shield (10) in said sensor device (302), wherein said gamma shield (3) is located between said source (2) and said measurement space (6) and/or wherein said neutron shield (10) is arranged between sad detector (8) and said measurement space (6).

15. A method according to claim 13, characterised in that the method further comprises minimisation of direct radiation of gamma from the neutron source (2) to said detector (8) of a gamma shield (5) arranged around said neutron source (2) in said sensor device (302).

16. A method according to claim 13, characterised in that the method comprises sorting of a flow of waste.

17. A method according to claim 13, characterised in that said detection is performed contact-free with respect to the object (308).

18. A method according to claim 13, characterised in that an estimate of the amount of sample material in said measurement space (6) is provided on the basis of gamma radiation of an elemental substance, eg hydrogen, aluminium, silicon or iron, present in the sample material in a known concentration.

19. A method according to claim 23, characterised in that said sensor device primarily comprises carbon material as moderator.

20. A method according to claim 13, characterised in that the method comprises receipt of measurements of objects of a known classification; and that the classification comprises means for calculating weight factors of a number of weighted sums established by a multivariable data analysis, calibration or an iterative method by which an incremental refining successively brings about an improved set of weight factors.

21. A method according to claim 20, characterised in the method further comprises that said control signal (307) is provided by the classification unit (303) on the basis of signals comprising said weight factors and said sensor signal (306).

22. A method according to claim 13, characterised in that the cluster analysis is used as a step in automatically generating suggestions for categorising sample objects on the basis of pattern in measurement data corresponding to these objects.

23. A method according to claim 13, characterised in that said sensor signal (306) comprises a gamma spectre representing registered gamma radiation intensity within a given photon/energy range.

24. A method according to claim 13, characterised in that said control signal (307) is provided on the basis of the difference between a sensor signal (306) and a predetermined reference spectre obtained with empty measurement space (6) and stored in a memory unit (403).
